(19) United States
(12) Patent Application Publication
(10) Pub. No.: US 2008/0216836 A1
(43) Pub. Date: Sep. 11, 2008

(54) Portable Breathing Apparatus for Divers

(75) Inventor: Nils T. Ottestad, Tonsberg (NO)

Correspondence Address: Ronald R Santucci;FROMMER LAWRENCE & HAUG, 745 Fifth Avenue, New York, NY, 10151, US

(73) Assignee: OTTESTAD BREATHING SYSTEMS AS, Husoysund (NO)

(21) Appl. No.: 11/663,942

(22) PCT Filed: Sep. 27, 2005
(86) PCT No.: PCT/NO05/00358

§ 371 Date: Feb. 13, 2008

(30) Foreign Application Priority Data
Sep. 27, 2004 (NO) 20044074

(51) Int. Cl. B63C 11/24; B63C 11/18; A62B 7/04

(52) U.S. Cl. 128/204.28; 128/205.24

(57) ABSTRACT

A portable semi-closed breathing apparatus for divers, having a circuit comprising a breathing bellows (1) connected to a pressure gas source (2) for the supply of breathing gas, a demand-controlled breathing valve (20), an actuator (4) for expansion and contraction of the breathing bellows (1) in step with the diver's breathing pattern, a means (5) for compensation of consumed oxygen, and a means (6) for removal of CO₂ from the breathing gas. The actuator (4) is a cylinder/piston unit (9, 10) having a first chamber (11) connected to a source (13) for compensation gas, and a second chamber (12) connected to a valve means (5). During the diver's exhalation phase the valve means (5) is arranged to supply compensation gas to said second chamber (12) under control of the breathing valve (20), so that the breathing bellows (1) expands and absorbs exhaled gas from the diver. During the inhalation phase the actuator (4) contracts the bellows (1) and the valve means (5) delivers compensation gas to the circuit in accurate correspondence with the gas quantity inhaled by the diver, in that the valve means is arranged to keep the pressure in the second chamber (12) at a preset level.

The invention relates to a portable semi-closed breathing apparatus for divers, having a circuit comprising a breathing bellows connected to a pressure gas source for the supply of breathing gas, a demand-controlled breathing valve, an actuator for expansion and contraction of the breathing bellows in step with the breathing pattern of the diver, a means for compensation of consumed oxygen, and a means for removal of CO₂ from the breathing gas.

A semi-closed breathing apparatus is based on recirculation of exhaled breathing air in a circuit wherein carbon dioxide (CO₂) is removed and wherein consumed oxygen is compensated for.

In order that a breathing apparatus for divers shall be easy to breathe with, it is necessary that the pressure in the respiratory passages of the diver at any time is kept on approximately the same level as the hydrostatic pressure in the water surrounding the breathing mask or breathing mouthpiece of the diver. For practical reasons it is customary to have the breathing bellows placed at the back. This entails that the hydrostatic pressure around the breathing bellows may be substantially different from the water pressure around the diver's mask/breathing mouthpiece. Therefore, when a passive breathing bellows is used, the breathing work sometimes will be substantially influenced by how the divers are oriented in the water. It is heavy to exhale when the breathing bellows lies low in relation to the mask/breathing mouthpiece. Correspondingly, it is heavy to inhale when the breathing bellows lies high. To a certain extent this can be compensated for, but an apparatus based on lung force for recirculation of breathing air, in any case will have poorer breathing properties than what can be achieved with a pneumatically assisted recirculation of the breathing air.

In order to maintain a desired oxygen level in recirculated breathing air, one is dependent on a constant supply of oxygen-containing gas. Pneumatic assistance can be achieved in that the pressure energy in this gas-supply is utilized to cause the breathing bellows to contract respectively expand in accordance with the diver's breathing demand. Norwegian patent No. 171 889, belonging to the applicant, shows an example of such a breathing apparatus, more specifically an apparatus of the type stated in the introduction. The known apparatus is based on a sensor means recording pressure variations in the breathing gas caused by the diver's inhalation and the exhalation, and which sees to it that the breathing bellows alternates between an overpressure and an underpressure dependent on whether the diver inhales or exhales. The pressure in the breathing bellows changes to 0.1 bar overpressure (in relation to the surrounding pressure of the bellows) when the diver is in the inhalation mode, and correspondingly to an underpressure of 0.1 bar when the diver is in the exhalation mode. The correct breathing pressure is achieved by means of a double-acting demand valve mounted on the diver's mask/breathing mouthpiece.

In professional diving it is customary that the diver operates by means of a diving bell submerged to the region wherein the diver operates. At larger depths the breathing air contains a percentage of helium to minimize the breathing work. Such gas is very expensive, and it is therefore customary to count on reuse. In bell-based diving it is customary to return exhaled gas to the surface for recovery. This is done in that the diver is connected to a supply cable (umbilical) running via the diving bell to the surface. In addition to a supply line and a return line for the breathing air, the supply cable contains hot water supply, communication lines, monitoring cables, etc.

There is always a risk that the gas supply can fail. It is therefore a requirement that the diver shall have a separate emergency system which can secure that he has sufficient air to be able to return to the diving bell if such problems arise. The diving bell is in turn provided with a reservoir of gas containers that are to secure a more long-term supply of breathing gas if problems arise in having the diving bell returned to the surface.

Within the sports diving environment and the more semi-professional environment there has been a strong development in the direction of using circuit apparatuses wherein the recirculation of the breathing air takes place in the breathing apparatus brought along by the diver. Such apparatuses are called rebreathers. The rebreathers available today normally are not used for commercial diving because they are considered not to be sufficiently secure in use. The security problems are especially associated with the control of the oxygen level in the recirculated air. Rebreathers are based on compensating for the oxygen consumption by controlled injection of an oxygen-rich compensation gas. The control device for this injection is based on electronic oxygen sensors. Failure in sensors or other parts of the control device may become fatal for the diver, irrespective of whether the oxygen level becomes too high or too low.

The object of the invention is to provide a portable semi-closed breathing apparatus which is reliable in use and as easy to breathe with as possible, and which at any time will be able to provide the diver with breathing gas of a satisfactory quality, care being taken that the oxygen level in the breathing gas is maintained at a stable level in that compensation gas is supplied to the circuit in precise accordance with the quantity of gas ventilated by the diver.

For the achievement of the above-mentioned object there is provided a breathing apparatus of the introductorily stated type which, according to the invention, is characterised in that the actuator is a cylinder/piston unit having a first chamber connected to a source for compensation gas, and a second chamber connected to a valve means arranged to supply compensation gas during the exhalation phase to the second chamber under control of the breathing valve, the breathing valve affecting a gas flow modulating valve having an inlet connected to the source for compensation gas, and an outlet connected to the valve means, and the valve means during the inhalation phase being arranged to deliver compensation gas to the circuit in precise proportions to the gas the quantity inhaled by the diver, in that the valve means delivers the quantity of gas required to keep the pressure in the second chamber at a preset level.

The breathing apparatus according to the invention primarily has been developed for use in commercial diving. The valve means controlling the breathing assistance, is arranged such that the breathing apparatus is immediately switched to the inhalation mode when the diver has stopped exhaling. This is registered by the sensor diaphragm in a demand valve mounted on the diver's mask/breathing mouthpiece. In this mode the cylinder/piston unit exerts a compressing force on the breathing bellows so that a fixed supply pressure is maintained to the demand valve which thereby is enabled to supply breathing air in accordance with the diver's demand. When the diver again starts exhaling, he creates an overpressure that is registered at the sensor diaphragm. This results in that the bellows immediately starts expanding, so that exhaled gas can be absorbed without significant breathing resistance. As soon as the diver stops exhaling, the breathing apparatus is again switched over to the inhalation mode.

The safety advantages of the breathing apparatus according to the invention are especially related to low breathing work and that one bases oneself on the compensation gas being directly breathable. In addition the diver will experience ergonomic advantages in that his supply cable (umbilical) becomes slender and thereby less rigid. This is primarily due to the fact that no return line for the breathing air is required.

The invention will be further described below in connection with exemplary embodiments with reference to the drawings, wherein

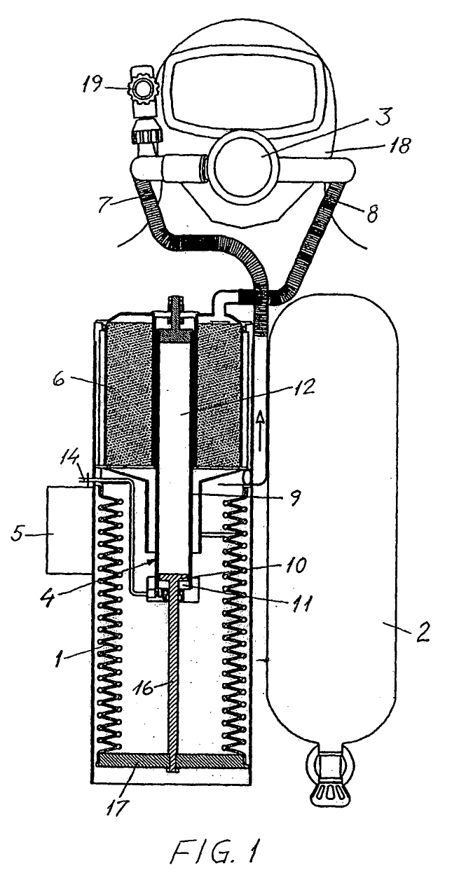

FIG. 1 shows a schematic, partly sectioned side view of the main components in a breathing apparatus according to the invention;

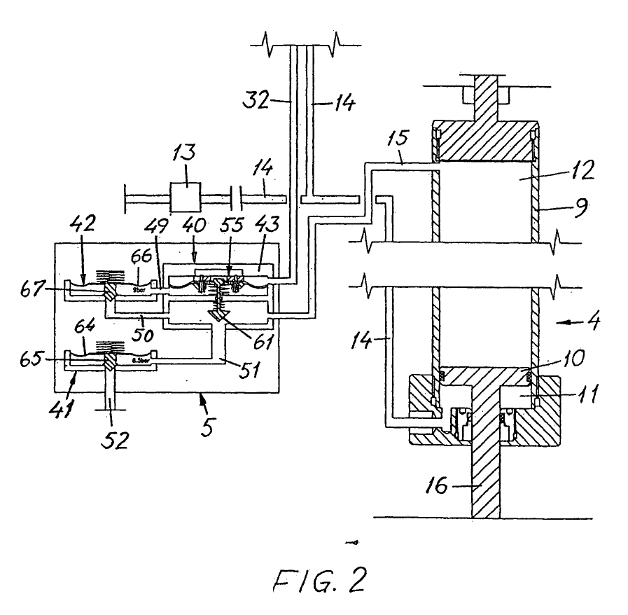

FIG. 2 shows a sectional view of an embodiment of the actuator and the valve means in the apparatus according to the invention;

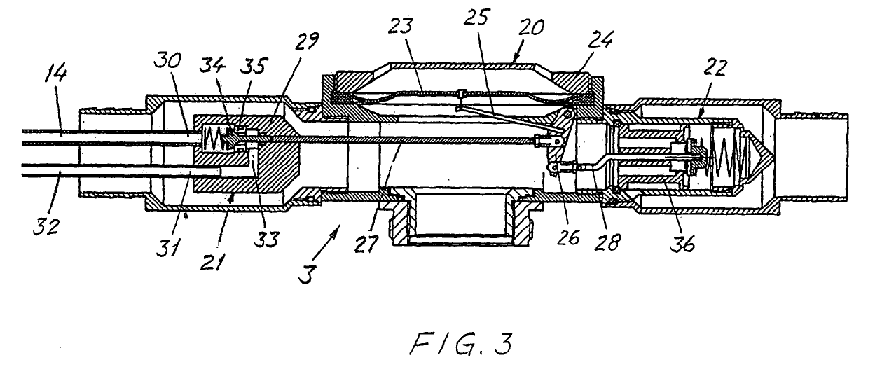

FIG. 3 shows a sectional view of an embodiment of a breathing valve unit forming part of the apparatus; and

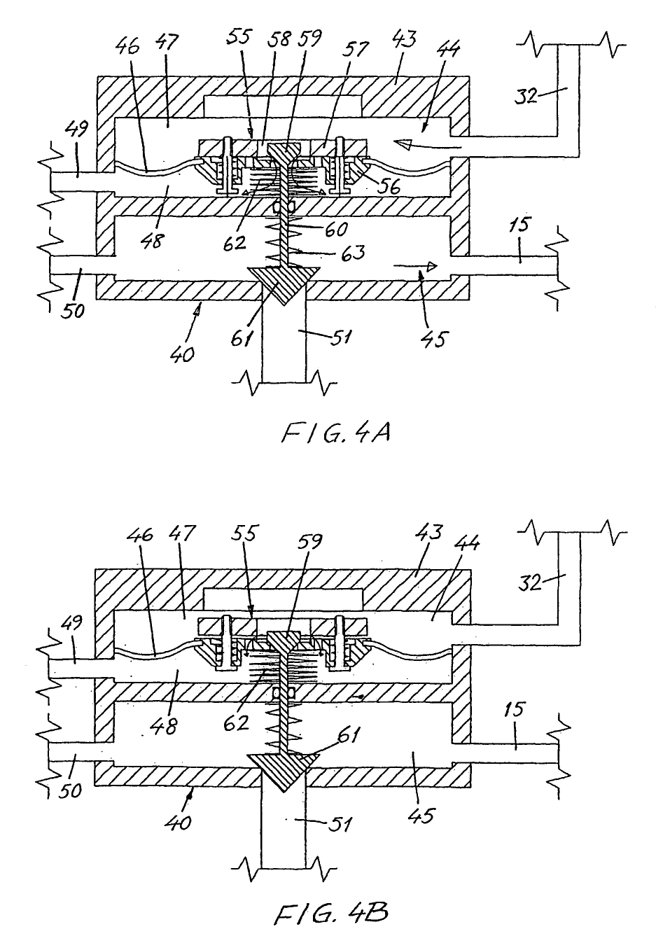

FIGS. 4A and 4B show sectional views of a change-over valve forming part of the valve means in FIG. 2, in two different functional positions.

As appears from FIG. 1, the main components of the breathing apparatus according to the invention comprise a breathing bellows 1 connected to a pressure source in the form of a compressed-air bottle 2 for supply of breathing gas, a breathing valve unit 3 with a demand valve, an actuator 4 for expansion or contraction of the breathing bellows 1, a valve means 5 for compensation of consumed oxygen, and an absorber (scrubber) 6 for continuous removal of CO₂ from the breathing gas directed through the circuit. Said components form part of a circuit which is also shown to comprise a supply hose 7 extending between the breathing bellows 1 and the valve unit 3, and an outlet hose 8 extending between the valve unit 3 and the absorber 6.

The breathing apparatus normally will be provided with breathing air through a supply cable from the surface. The gas stored in the brought-along compressed air bottle 2 that the diver has fixed to the back, is to function as emergency gas if the surface supply fails.

As best shown in FIG. 2, the actuator 4 consists of a cylinder/piston unit comprising a cylinder 9 and a piston 10 slidably arranged in the cylinder and delimiting a first chamber 11 and a second chamber 12. The first chamber 11 is connected to a source for compensation gas which, through a regulator 13 and a supply line 14, is supplied with a stabilized pressure which, in the present embodiment, is chosen to be 12 bar (i.e. an overpressure of 12 bar relative to the hydrostatic pressure in surrounding body of water). The second chamber 12 is connected through a line 15 to the valve means 5 which is arranged to supply a desired quantity of compensation gas to the circuit under control of is the demand valve in the breathing valve unit 3 (see FIG. 3), as further described later in the description.

In the shown breathing apparatus the ability to give breathing assistance is combined with the actuator being dimensioned so that it supplies exactly the quantity of compensation gas required to maintain a desired oxygen level in the recirculated gas. The relevant dimensions can readily be determined mathematically.

In order that the actuator 4 shall dose in a correct (sufficient) quantity of compensation gas without simultaneously becoming too strong, there is established, by means of the valve means 5, a “counter-pressure” of 6.5 bar at the side of the piston 9 facing the chamber 12, whereas the supply pressure on the other side of the piston as mentioned is kept fixedly at 12 bar. Thereby the actuator's consumptions of compensation gas is increased for each liter of breathing gas recirculated in the circuit.

As shown in FIG. 1, the piston 10 is connected through a piston rod 16 to a bottom plate 17 in the breathing bellows. This bottom plate is dimensioned such that, in cooperation with the prevailing pressures in the chambers 11 and 12 and the pressure-influenced piston surfaces, in the inhalation phase it produces a fixed overpressure of e.g. 0.1 bar in the interior of the breathing bellows 1.

FIG. 3 shows a sectional view of the breathing valve unit 3 in FIG. 1. This unit is mounted on the diver's mask/breathing mouthpiece 18 (FIG. 1) and comprises a demand valve 20, a valve 21 for modulation of the flow of compensation gas, an inhalation valve 22 and an exhalation valve (not shown).

The demand valve 20 comprises a sensor diaphragm 23 recording the diver's breathing demand and moving outwards and inwards in the valve housing 24 in step with the breathing pattern of the diver. In its central region the diaphragm 23 is connected to an arm 25 transferring the movements of the diaphragm to an operating arm 26 rotatably fixed to the valve housing 24 and being connected to a first operating rod 27 for influencing the modulating valve 21, and a second operating rod 28 for influencing the inhalation valve 22.

The valve 21 for modulation of the flow of compensation gas comprises a valve housing 29 having an inlet 30 that is connected to the supply line 14 for compensation gas, and having an outlet 31 that is connected to a line 32 leading to the valve means 5 as shown in FIG. 2. In the passage 33 between the inlet and the outlet there is arranged a spring-loaded valve body 34 resting against a seat 35 and being connected to the operating rod 27. The passage 33 thus is opened and closed under the influence of the demand valve 20, so that the quantity of compensation gas that is allowed to flow through the valve 21, is modulated in accordance with the breathing demand of the diver.

The inhalation valve 22 comprises a spring-loaded piston 36 connected to the operating rod 28. The valve is controlled in that the underpressure created during the diver's inhalation pulls the sensor diaphragm 23 of the demand valve inwards from its is center position and thereby influences the operating rod 28 through the arms 25 and 26 so that the piston 36 is pressed to open position. This valve in its entirety is based on the applicant's Norwegian patent No. 174 120 and therefore will not be further described. The valve is dimensioned so that it has the desired supply capacity at a supply pressure of 0.1 bar.

The valve means 5 which is schematically suggested in FIG. 1, is shown more in detail in FIG. 2. The means comprises a switching or change-over valve 40 and two dump valves 31 and 42. The components forming part of the change-over valve, are shown more clearly in the enlarged views in FIGS. 4A and 4B.

The change-over valve 40 comprises a housing 43 having an upper space 44 and a lower space 45. In the upper space 44 there is fixed a diaphragm 46 dividing the space in a first or upper chamber 37 and a second or lower chamber 48. The upper chamber 47 is connected to a line 32 which is connected to the outlet from the modulating valve 21 in the breathing valve unit 3, whereas the lower chamber 48 is connected through a duct 49 to an inlet to the dump valve 42. An outlet from the dump valve 42 is connected via a duct 50 to the lower space 45 in the housing 43 of he change-over valve. This space is also connected to the line 15 which is connected to the second chamber 12 in the actuator cylinder 9, and further is connected to the inlet of the dump valve 41 via a duct 51. An outlet from the dump valve 41 is connected to a duct 52 for direct supply of compensation gas to the circuit of the breathing apparatus, as further described later.

In the central region of the diaphragm 46 in the upper space 44 of the change-over valve there is arranged a switching unit 55 comprising a pressure disc 56 attached to the diaphragm and a top plate 57 which by means of guide means is resiliently interconnected with the pressure disc and has a central opening 58. The pressure disc has a center opening forming a seat for cooperation with a first valve body 59, and around the central opening there are arranged a number of openings for through-flow of gas, as described below in connection with the manner of operation of the valve means. The valve body 59 is connected through a guide rod 60 to an additional valve body 61 which is adapted to cooperate with a seat at the inlet of the duct 51.

The guide rod 60 is surrounded by a main spring 62 placed between the pressure disc 56 and the bottom surface of the chamber 48. The guide rod 60 is also surrounded by an auxiliary spring 63 placed between the additional valve body 61 and the top surface of the space 45.

As shown in FIG. 2, the dump valve 41 comprises a chamber which is partly defined by a spring-loaded diaphragm 64 influencing a valve body 65. The valve is arranged to close the outlet to the duct 50 when the pressure in the valve chamber sinks below approximately 6.5 bar.

The dump valve 42 comprises a chamber which is partly defined by a spring-loaded diaphragm 66 influencing a valve body 67. This valve is arranged to close the is outlet to the duct 50 when the pressure in the valve chamber sinks below approximately 9 bar.

The manner of operation of the breathing apparatus according to the invention will be further described below.

FIG. 1 shows the flow direction in the circuit as the diver starts inhaling. In this situation the breathing bellows 1 is approximately completely filled with air and keeps an overpressure of ca. 0.1 bar in relation to the surrounding pressure of the bellows. In this mode the supply of breathing air to the diver is controlled in the same manner as in a traditional demand system in that the sensor diaphragm 23 of the demand valve registers the breathing demand of the diver and provides for the desired gas supply by controlling the flow cross-section through the inhalation valve 22.

When the diver exhales, the sensor diaphragm 23 of the demand valve 20 is pressed outwards and causes the operating rod 27 to press the valve body 34 in the modulating valve 21 away from its seat 35. Thereby a delivery of compensation gas to the valve means 5 via the conduit 32 is started. The valve means directs this gas further to the second chamber 12 of the actuator, so that the breathing bellows 1 expands and absorbs the gas exhaled by the diver.

FIG. 4A shows what happens when the change-over valve 40 is provided with gas through the conduit 32. This gas can not flow further into the chamber 48 before the valve body 61 has been pressed down against the seat and prevents gas from flowing out of the duct 51. When this has occurred, the supplied gas will be able to flow further as shown by arrows. The gas then flows into the dump valve 42 which is only open for through-flow into the second chamber 12 in the actuator 4, so that the breathing bellows 1 expands if the pressure out of the chamber 48 exceeds approximately 9 bar. The reason for this is that one wants to prevent the pressure in the conduit 32 from sinking below 9 bar, for achieving in this manner that a little force is required to press the valve body 34 away from the seat 35 and produce the supply of compensation gas.

FIG. 4B shows what happens when the diver has finished the exhalation. The main spring 62 in the change-over valve 40 then will immediately press the pressure disc 56 upwards until the valve body 59 closes for the gas flow shown in FIG. 4A. In this situation the pressure in the chamber 47 of the change-over valve is somewhat higher than the pressure in the chamber 48, so that the valve body 61 still prevents gas from flowing out through the duct 51. A small leakage in the fit between the pressure disc 56 and the top plate 57 sees to it that the pressure difference between the chambers is quickly reduced, and the pressure disc and the top plate then will quickly be pressed away from each other and equalize the pressure quickly by creating a leakage between the chambers as shown with arrows through the openings in the pressure disc 56. This pressure equalisation entails that the valve body 61 is pulled upwards by the main spring 62, so that there is opened for gas to flow out from the duct 51. This process takes place in a fraction of a second and implies that the breathing apparatus has switched over to inhalation mode. In the inhalation mode the chamber 12 is put in open connection with the dump valve 41 which sees to it that the pressure in this chamber is now lowered to approximately 6.5 bar. The breathing bellows 1 consequently is compressed by a force determined by the pressure difference between the chamber 11 and the chamber 12 being maintained at ca. 5.5 bar as long as the breathing apparatus is in the inhalation mode.

When the diver inhales, the chamber 12 will be compressed and compensation gas will be dumped via the duct 52. This duct dumps compensation gas directly into the circuit. The quantity of gas supplied to the circuit, will be directly proportional to the quantity of gas ventilated by the diver. As the diver only consumes oxygen from the supplied breathing air, gas must be dumped continuously from the circuit. This takes place via a non-illustrated device which in a preferred embodiment is based on activation of an exhalation valve in the demand valve 20 as soon as the breathing bellows 1 is filled beyond a defined maximum level.

The breathing apparatus according to the invention has a self-regulating function with respect to maintaining a predictable and safe oxygen level in the recirculated breathing air.

The valve means is arranged in such a manner that the breathing system becomes extremely heavy to breathe with if a fault arises which influences the quantity of supplied compensation gas. The diver thus will distinctly register if the valve means does not function. He will then be able to switch over to an emergency mode by opening a valve 18 shown in FIG. 1, so that the diver is supplied with an undiluted compensation air from the supply cable, or alternatively from the emergency reservoir that he has on the back.

Theoretically, a traditional bell-based diver system with gas recovery shall be able to take care of nearly 100% of the gas which is recirculated. In practice operational problems and leakages will cause that a real recovery percentage is 80-85%. In comparison, a breathing apparatus according to the invention typically will achieve a recovery percentage of ca. 94% at a depth of 200 meters. Thus, the real consumption of compensation air is substantially lower than what is achieved in a traditional bell-based diving system.

1. A portable semi-closed breathing apparatus for divers, having a circuit comprising a breathing bellows connected to a pressure gas source for the supply of breathing gas, a demand-controlled breathing valve, an actuator for expansion and contraction of the breathing bellows in step with the breathing pattern of the diver, a means for compensation of consumed oxygen, and a means for removal of CO₂ from the breathing gas, wherein the actuator is a cylinder/piston unit having a first chamber connected to a source for compensation gas, and a second chamber connected to a valve means arranged to supply compensation gas during the exhalation phase to the second chamber under control of the breathing valve, the breathing valve affecting a gas flow modulating valve having an inlet connected to the source for compensation gas, and an outlet connected to the valve means, and the valve means during the inhalation phase being arranged to deliver compensation gas to the circuit in precise proportion to the gas quantity inhaled by the diver, in that the valve means delivers the quantity of gas required to keep the pressure in the second chamber at a preset level.

2. A breathing apparatus according to claim 1, wherein the piston is connected via a piston rod to a bottom plate arranged in the breathing bellows and being dimensioned so that, in the inhalation phase, in cooperation with the prevailing pressures in the chambers of the cylinder and the pressure-influenced piston surfaces, it produces a fixed overpressure of for example 0.1 bar in the interior of the breathing bellows.

3. A breathing apparatus according to claim 1, wherein the modulating valve comprises a valve body arranged to open and close a passage between the inlet and outlet of the valve under the influence of the breathing valve, so that the quantity of compensation gas flowing through the modulating valve is modulated in accordance with the breathing demand of the diver.

4. A breathing apparatus according to claim 1, wherein the valve means comprises a change-over valve arranged to cooperate with a pair of dump valves, so that the flow of compensation gas is alternately supplied to the second chamber of the actuator for expansion of the breathing bellows and to the circuit of the breathing apparatus, the change-over valve comprising a switching unit that is automatically switched when the inhalation mode is finished, so that compensation gas is allowed to flow from said second chamber and into the circuit.

5. A breathing apparatus according to claim 2, wherein the modulating valve comprises a valve body arranged to open and close a passage between the inlet and outlet of the valve under the influence of the breathing valve, so that the quantity of compensation gas flowing through the modulating valve is modulated in accordance with the breathing demand of the diver.

6. A breathing apparatus according to claim 2, wherein the valve means comprises a change-over valve arranged to cooperate with a pair of dump valves, so that the flow of compensation gas is alternately supplied to the second chamber of the actuator for expansion of the breathing bellows and to the circuit of the breathing apparatus, the change-over valve comprising a switching unit that is automatically switched when the inhalation mode is finished, so that compensation gas is allowed to flow from said second chamber and into the circuit.

7. A breathing apparatus according to claim 3, wherein the valve means comprises a change-over valve arranged to cooperate with a pair of dump valves, so that the flow of compensation gas is alternately supplied to the second chamber of the actuator for expansion of the breathing bellows and to the circuit of the breathing apparatus, the change-over valve comprising a switching unit that is automatically switched when the inhalation mode is finished, so that compensation gas is allowed to flow from said second chamber and into the circuit.
